(19) United States
(12) Patent Application Publication
(10) Pub. No.: US 2012/0208968 A1
(43) Pub. Date: Aug. 16, 2012

(54) CATALYST COMPONENTS FOR THE POLYMERIZATION OF OLEFINS AND CATALYSTS THEREFROM OBTAINED

(75) Inventors: Friedhelm Gundert, Liederbach (DE); Martin Schneider, Hochheim (DE)

(73) Assignee: BASELL POLYOLEFINE GMBH, Wesseling (DE)

(21) Appl. No.: 13/502,044

(22) PCT Filed: Oct. 7, 2010
(86) PCT No.: PCT/EP10/65010

§ 371 Date: Apr. 13, 2012

(30) Foreign Application Priority Data
Oct. 22, 2009 (EP) 09173752.8

(51) Int. Cl. C08F 10/02; C08F 4/646

(52) U.S. Cl. 526/124.2; 502/158; 502/125

(57) ABSTRACT

A catalyst component for the polymerization of olefins obtainable by:
(a) reacting a Mg(OR₁)(OR₂) compound, in which R₁ and R₂ are identical or different and are each an alkyl radical having 1 to 10 carbon atoms, with a tetravalent transition metal compound having at least a metal-halogen bond, the molar ratio metal/Mg ranging from 0.05 to 10, thereby obtaining a solid reaction product, and
(b) contacting the solid reaction product obtained in step (a) with a silicon compound of formula R^{I}Si(OR^{II})₃ where R^{I} is a linear, branched, cyclic or aromatic C₁-C₂₀ hydrocarbon group and R^{II} is a linear, branched, cyclic or aromatic C₂-C₂₀ hydrocarbon group, the molar ratio of the silicon compound on the transition metal in the solid reaction product of step (a) ranging from 0.1 to 3.

This application is the U.S. national phase of International Application PCT/EP2010/065010, filed Oct. 7, 2010, claiming priority to European Application 09173752.8 filed Oct. 22, 2009 and the benefit under 35 U.S.C. 119(e) of U.S. Provisional Application No. 61/279,592, filed Oct. 23, 2009; the disclosures of International Application PCT/EP2010/065010, European Application 09173752.8 and U.S. Provisional Application No. 61/279,592, each as filed, are incorporated herein by reference.

The present invention relates to catalyst components for the polymerization of olefins CH₂═CHR, wherein R is hydrogen or hydrocarbon radical having 1-12 carbon atoms. In particular, the invention relates to catalyst components suitable for the preparation of homopolymers and copolymers of ethylene and to the catalysts obtained therefrom. In particular, the present invention relates to solid catalyst components, comprising titanium magnesium and halogen, and obtainable by a reaction with specific electron donors compounds.

The catalysts of the invention are suitably used in (co)polymerization processes of ethylene to prepare (co)polymers having narrow Molecular Weight Distribution (MWD) and high activity. The MWD is an important characteristic of ethylene polymers in that it affects both the rheological behavior, the processability and the final mechanical properties of said polymers. In particular, polymers with narrow MWD are suitable for cast films and injection moulding in that deformation and shrinkage problems in the manufactured article are minimized. The width of the molecular weight distribution for the ethylene polymers is generally expressed as melt flow rate ratio FRR_{21.6/5} or melt flow rate ratio FRR_{21.6/2.16}, respectively. FRR_{21.6/5} is the ratio between the melt index measured by a load of 21.6 Kg and that measured with a load of 5 Kg, whereas FRR_{21.6/2.16} is the ratio between the melt index measured by a load of 21.6 Kg and that measured with a load of 2.16 Kg. The measurements of melt index are carried out according to ISO1133 and at 190° C. Catalyst components having the capability of producing polymers with narrow molecular weight distribution are also useful to prepare polymer compositions with broad molecular weight distribution. In fact, one of the most common methods for preparing broad MWD polymers is the multi-step process based on the production of different molecular weight polymer fractions in each step, sequentially forming macromolecules with different length on the catalyst particles.

The control of the molecular weight obtained in each step can be obtained according to different methods, for example by varying the polymerization conditions or the catalyst system in each step, or by using a molecular weight regulator. Regulation with hydrogen is the preferred method in industrial plants. It has been observed that final compositions of optimal properties are obtainable when using a catalyst able to provide polymers with narrow MWD and different average Mw in each single step that, when combined together form final compositions with broad molecular weight distribution. In these multistep processes a critical step is that in which the lower average molecular weight polymer fraction is prepared. In fact, one of important features that the catalyst should possess is the so called “hydrogen response”, that is the extent of capability to reduce the molecular weight of polymer produced in respect of increasing hydrogen concentration. Higher hydrogen response means that a lower amount of hydrogen is required to produce a polymer with a certain molecular weight. In turn, a catalyst with good hydrogen response would also usually display a higher activity in ethylene polymerization due to the fact that hydrogen has a depressive effect on the catalyst activity. Moreover, it is also important that the polymer chains show a limited amount of long chain branching which in some applications are responsible for lowering certain properties like impact strength and ESCR. In view of the above, it would be therefore useful to have a catalyst component able to provide ethylene polymers with narrow molecular weight distribution, combined with a good balance of polymerization activity and morphological stability.

A catalyst component for use in ethylene (co)polymerization is described in the WO03/099882. It concerns polymerizing in the presence of a catalyst consisting of the product of the reaction of a magnesium alkoxide with a transition-metal compound (component a) and an organometallic compound (component b). The component (a) has been produced by reacting a transition-metal compound of titanium with a gelatinous dispersion of the magnesium alkoxide in an inert hydrocarbon having specific particle size distribution. Although showing properties of interest the catalyst did not produce sufficiently narrow molecular weight distribution.

WO2009/027270 teaches to narrow the molecular weight distribution by using an external polymerization modifying agent selected from silane compounds of formula HRmSi(OR)n in which R is a C₁-C₂₀ alkyl group m is 0 or 1, n is (3-m). Although some results are obtained, the said document does not mention the possibility of using the said silanes in the catalyst component preparation and also does not mention the possibility of preparing the catalyst component by starting from Mg alkoxides.

US2007/0259777 describes a method for preparing a solid catalyst for ethylene polymerization and/or copolymerization. More specifically, the document relates to a method for preparing a solid titanium catalyst comprising the steps of (i) reacting a magnesium compound solution with a silicon compound containing an alkoxy group to obtain a silicon-containing magnesium compound solution and (ii) adding the silicon-containing magnesium compound solution in a titanium compound. The silicon compound can have formula Si(R¹)(R²)(OR³) in which wherein R¹ is trimethylsilylmethyl or 2-phenylpropyl; R² is linear, cyclic or branched alkyl of C₃-C₆ such as 1-hexyl, cyclohexyl, cyclopentyl, n-butyl, iso-butyl or propyl; and R³ is alkyl of C₁-C₃. Alternatively the silicon compound can have formula R¹ₐR²_{b}Si(OR³)_{4-(a+b)} in which R¹ and R² are individually hydrocarbon of C1-C12; R³ is hydrocarbon of C₁-C5, a is 0 or 1 and b is 0 or 1. The so obtained catalyst is said to be active and able to produce a polymer with a high bulk density, a narrow and uniform particle size distribution, but provide polymers with a broad molecular weight distribution.

Accordingly, it was surprising to discover that the use of certain specific silicon compound in a particular process for catalyst preparation rendered a catalyst able to prepare with high activity ethylene polymers with narrow molecular weight distribution. Therefore, it is an object of the present invention a catalyst component for the polymerization of olefins obtainable by:

(a) reacting a Mg(OR₁)(OR₂) compound, in which R₁ and R₂ are identical or different and are each an alkyl radical having 1 to 10 carbon atoms, with a tetravalent transition metal compound having at least a metal-halogen bond, the molar ratio metal/Mg ranging from 0.05 to 10, thereby obtaining a solid reaction product, and

(b) contacting the solid reaction product obtained in step (a) with a silicon compound of formula R^{I}Si(OR^{II})₃ where R^{I} is a linear, branched, cyclic or aromatic C₁-C₂₀ hydrocarbon group and R^{II} is a linear, branched, cyclic or aromatic C₂-C₂₀ hydrocarbon group, the molar ratio of the silicon compound on the transition metal in the solid reaction product of step (a) ranging from 0.1 to 3.

Preferably R^{II} is a linear or branched C₂-C₅ alkyl, in particular ethyl or n-propyl. R^{I} is preferably a linear, branched or cyclic alkyl radical or an aryl radical having from 3 to 10 carbon atoms. Still more preferably, R^{I} is selected from propyl, isopropyl, isobutyl, cyclopentyl, and phenyl.

Non limiting exemplary silicon compounds include propyltriethoxysilane, isopropyltriethoxysilane, butyltriethoxysilane isobutyltriethoxysilane, cyclopentyltriethoxysilane, phenyltriethoxysilane, methyltrisoproxysilane.

In the preparation of the catalyst component (A), R₁ and R₂ are preferably alkyl groups having from 2 to 10 carbon atoms or a radical —(CH₂)ₙOR₃, where R₃ is a C₁-C₄-alkyl radical and n is an integer from 2 to 6. Preferably R₁ and R₂ are C₁-C₂-alkyl radical. Examples of such magnesium alkoxides are: magnesium dimethoxide, magnesium diethoxide, magnesium di-1-propoxide, magnesium di-n-propoxide, magnesium di-n-butoxide, magnesium methoxide ethoxide, magnesium ethoxide n-propoxide, magnesium di(2-methyl-1-pentoxide), magnesium di(2-methyl-1-hexoxide), magnesium di(2-methyl-1-heptoxide), magnesium di(2-ethyl-1-pentoxide), magnesium di(2-ethyl-1-hexoxide), magnesium di(2-ethyl-1-heptoxide), magnesium di(2-propyl-1-heptoxide), magnesium di(2-methoxy-1-ethoxide), magnesium di(3-methoxy-1-propoxide), magnesium di(4-methoxy-1-butoxide), magnesium di(6-methoxy-1-hexoxide), magnesium di(2-ethoxy-1-ethoxide), magnesium di(3-ethoxy-1-propoxide), magnesium di(4-ethoxy-1-butoxide), magnesium di(6-ethoxy-1-hexoxide), magnesium dipentoxide, magnesium dihexoxide. Preference is given to using the simple magnesium alkoxides such as magnesium diethoxide, magnesium di-n-propoxide and magnesium di-1-butoxide with magnesium diethoxide being the most preferred. The magnesium alkoxide is used as a suspension or as a gel dispersion preferably in the pure form.

In general, commercially available Mg(OC₂H₅)₂ has average particle diameter ranging from 200 to 1200 μm preferably from 500 to 800 μm. Preferably before the reaction with the transition metal halide the magnesium alcoholate is suspended in an inert, saturated hydrocarbon. In order to lowering the magnesium alcoholate particle size, the suspension can be subject to high shear stress conditions by means of a high-speed disperser (for example Ultra-Turrax or Dispax, IKA-Maschinenbau Janke & Kunkel GmbH) working under inert atmosphere (Ar or N₂). Preferably the shear stress is applied until a gel-like dispersion is obtained. This dispersion differs from a standard suspension in that it is substantially more viscous than the suspension and is gel-like. Compared with the suspended magnesium alcoholate, the dispersed magnesium alcoholate settles out much more slowly and to a far lesser extent. The magnesium alkoxide is firstly reacted with the tetravalent transition metal compound of the formula (II)

MXₘ(OR₄)₄, (II),

where M is titanium, zirconium or hafnium, preferably titanium or zirconium, R₄ is an alkyl radical having from 1 to 9, preferably from 1 to 4 carbon atoms and X is a halogen atom, preferably chlorine, and m is from 1 to 4, preferably from 2 to 4.

Examples which may be mentioned are: TiCl₄, TiCl₃(OC₂H₅), TiCl₂(OC₂H₅)₂, TiCl(OC₂H₅)₃, TiCl₃(OC₃H₇), TiCl₂(OC₃H₇)₂, TiCl(OC₃H₇)₃, TiCl₃(OC₄H₉), TiCl₂(OC₄H₉)₂, TiCl(OC₄H₉)₃, TiCl₃(OC₆H₁₃), TiCl₂(OC₆H₁₃)₂, TiCl(OC₆H₁₃)₃, ZrCl₄, preference is given to using TiCl₄ or ZrCl₄. Particular preference is given to TiCl₄.

The reaction of the magnesium alkoxide with the tetravalent transition metal compounds is carried out at a temperature at from 20 to 140° C., preferably from 60 to 90° C., over a period of from 1 to 20 hours. Suitable inert suspension media for the above-mentioned reactions include aliphatic and cycloaliphatic hydrocarbons such as butane, pentane, hexane, heptane, cyclohexane, isooctane and also aromatic hydrocarbons such as benzene and xylene. Petroleum spirit and hydrogenated diesel oil fractions which have carefully been freed of oxygen, sulfur compounds and moisture can also be used.

The magnesium alkoxide and the tetravalent transition metal compound can be reacted in a molar ratio of Metal/Mg ranging from 0.05 to 10, preferably from 0.1 to 3, more preferably 0.15 to 0.7. The reaction is carried out in suspension, under stirring at a temperature ranging from 60 to 140° C., preferably from 70 to 90° C., within 0.1 to 10 hours, preferably within 1 to 7 hours. At the end of the reaction a solid product is obtained by removing of the liquid phase. Optionally, one or more washing step with inert hydrocarbon can be carried out until the supernatant mother liquor has Cl and Ti concentrations of less than 10 mmol/dm³. Preference is given to the performance of this washing step.

According to a preferred preparation method, the reaction product of magnesium alkoxide and the tetravalent transition metal compound is combined with the silicon compound of formula R^{I}ₐR^{II}_{b}Si(OR^{III})_{4-(a+b)} reported above. The aforementioned silicon compound can be added in a molar ratio of 0.1 to 3, preferably from 0.3 to 1 with respect to transition metal fixed on the solid component after the reaction with magnesium alkoxide. The reaction is carried out in suspension under stirring at a temperature ranging from 0 to 150° C., preferably from 60 to 120° C. within 0.5 to 5 hours, preferably from 1 to 2 hours.

According to an optional, although preferred method, an organometallic compound of a metal of group 1, 2 or 13 of the Periodic Table is reacted with the solid reaction product of step (a) or with the solid reaction product of step (b). Preferably, the organometallic compound is chosen among organoaluminum compounds. Suitable organoaluminum compounds are chlorine-containing organoaluminum compounds, e.g. dialkylaluminum monochlorides of the formula R³₂AlCl or alkylaluminum sesquichlorides of the formula R³₃Al₂Cl₃, where R³ is an alkyl radical having from 1 to 16 carbon atoms. Examples which may be mentioned are (C₂H₅)₂AlCl, (iC₄H₉)₂AlCl, (C₂H₅)₃Al₂Cl₃. It is also possible to use mixtures of these compounds.

The organoaluminium compound can be added in a molar ration of 0.1 to 2, preferably from 0.3 to 1 with respect to magnesium alkoxide. The reaction is carried out in suspension under stirring at a temperature ranging from 0 to 150° C., preferably from 60 to 120° C. within 0.5 to 7 hours, preferably from 1 to 5 hours.

According to a preferred method the organometallic compound is reacted with the reaction product (a) of magnesium alkoxide and the tetravalent transition metal and after that, reaction stage (b) takes place.

At the end of the preparation process the particle size of the catalyst component (component A) preferably ranges from 5 to 30 μm.

The catalyst component of the invention can be converted into active catalyst system by reacting it with a trialkylaluminum (component B) having from 1 to 6 carbon atoms in the alkyl radical, e.g. triethylaluminum, triisobutylaluminum, triisohexylaluminum, Preference is given to triethylaluminum and triisobutylaluminum.

The mixing of the component (A) and the component (B)can be carried out in a stirred vessel at a temperature of from −30° C. to 150° C. prior to the polymerization. It is also possible to combine the two components directly in the polymerization vessel at a polymerization temperature of from 20° C. to 200° C. However, it is preferred to carry out the addition of the component (B) in two steps by pre-activating the component (A) with part of the component (B) at a temperature of from −30° C. to 150° C. prior to the polymerization reaction and adding the remainder of the component (B) in the polymerization reactor at a temperature from 20° C. to 200° C.

The pre-activation is usually carried out using an aliquot of component (B) such that the Al/Ti molar ratio is less than 2 and preferably less than 1. Preferably, the initial contact temperature ranges from 0° C. to 60° C. while a further stage at a temperature ranging from 80° C.-140° C. is preferably added. The whole pre-activation step can preferably last from 0.5 to 5 hours.

It is also possible firstly to prepolymerize the pre-activated catalyst system with alpha-olefins, preferably linear C2-C10-1-alkenes and in particular ethylene or propylene, and then to use the resulting pre-polymerized catalyst solid in the actual polymerization. The mass ratio of catalyst solid used in the pre-polymerization to monomer polymerized onto it is usually in the range from 1:0.1 to 1:20.

It is also possible to isolate the catalyst in the non-prepolymerized form or in the pre-polymerized form and store it as a solid and re-suspend it on later use.

The catalysts systems of the invention are particularly suited for liquid phase polymerization process. In fact, the small average particle size of the component (A), such as less than 30 μm, preferably ranging from 5 to 20 μm, is particularly suited for slurry polymerization in an inert medium, which can be carried out continuously stirred tank reactor or in loop reactors. In a preferred embodiment the polymerization process is carried out in two or more cascade loop or stirred tank reactors producing polymers with different molecular weight and/or different composition in each reactor. In addition, to the ethylene homo and copolymers mentioned above the catalysts of the present invention are also suitable for preparing very-low-density and ultra-low-density polyethylenes (VLDPE and ULDPE, having a density lower than 0.920 g/cm³, to 0.880 g/cm³) consisting of copolymers of ethylene with one or more alpha-olefins having from 3 to 12 carbon atoms, having a mole content of units derived from ethylene of higher than 80%; elastomeric copolymers of ethylene and propylene and elastomeric terpolymers of ethylene and propylene with smaller proportions of a diene having a content by weight of units derived from ethylene of between about 30 and 70%.

The following examples are given in order to further describe the present invention in a non-limiting manner.

### EXAMPLES

The results for the elemental composition of the catalysts described reported in the examples were obtained by the following analytical methods:
Ti: photometrically via the peroxide complex
Mg, Cl: titrimetrically by customary methods
MFR_{5/190}: mass flow rate (melt index) in accordance with ISO1133, nominal load=5 kg and test temperature=190° C.
FRR_{21.6/5}: Flow rate ratio in accordance with EN ISO1133:

FRR_{21.6/5}=(MFR_{21.6/190}/MFR_{5/190})
FRR_{21.6/2.16}: Flow rate ratio in accordance with EN ISO1133:

FRR_{21.6/2.16}=(MFR_{21.6/190}/MFR_{2.16/190})
Bulk density: in accordance with DIN EN ISO 60
d₅₀ (mean particle diameter): in accordance with DIN 53477 and DIN66144

### Example 1

### Preparation of the Catalyst Component (A)

114 g (1 mol) of commercial Mg(OC₂H₅)₂ were suspended in diesel oil (hydrogenated petroleum fraction having a boiling range of 140-170° C.) (total volume: 1.0 dm³). The suspension was converted into a dispersion in a cylindrical glass vessel under inert gas (Ar) to exclude moisture and air (O₂) using a high-speed stirrer (®Ultra-Turrax) with external cooling by means of an ice bath (time: about 8 hours). The dispersion had a gel-like consistency. A volume of 0.25 dm³ (containing 0.25 mol of Mg(OC₂H₅)₂) of the gel-like dispersion was transferred to a 1 dm³ glass flask provided with reflux condenser, 2-blade blade stirrer and inert gas blanketing (Ar), and 0.25 dm³ of diesel oil having a boiling range of 140-170° C. (hydrogenated petroleum fraction) was added and the mixture was stirred at room temperature for 10 minutes at a stirrer speed of 100 rpm.

This gel-like dispersion was brought to 70° C. while stirring at a stirrer speed of 250 rpm and 0.075 mol of TiCl₄ in 50 cm³ of diesel oil (hydrogenated petroleum fraction having a boiling range of 140-170° C.) was subsequently metered in over a period of 4 hours. After a post-reaction time of 0.5 hour, the mixture was heated to 110° C. Subsequently 0.175 mol of Al₂(C₂H₅)₃Cl₃ in 200 cm³ of diesel oil (hydrogenated petroleum fraction having a boiling range of 140-170° C.) was metered in over a period of 2 hours while stirring at a stirrer speed of 250 rpm. The temperature was subsequently held at 110° C. for a further 2 hours. Afterwards the suspension is cooled down to ambient temperature and the stirrer is switched off. After the solid had settled, the supernatant liquid phase (mother liquor) was taken off. The solid was subsequently resuspended in fresh diesel oil (hydrogenated petroleum fraction having a boiling range from 140 to 170° C.) and after a stirring time of 15 minutes and subsequent complete settling of the solid, the supernatant liquid phase was taken off again. This washing procedure was repeated several times until chlorine and titanium concentration of the supernatant liquid phase is below 1 0 mmol/dm³.

Afterwards the suspension is heated up again under stirring at 250 rpm to a temperature of 85° C. Then phenyltriethoxysilane in an amount corresponding to a molar ratio of 0.5:1 with respect to titanium is metered in over a period of 1 hour. After a post-reaction of 0.5 hours the suspension is cooled down to ambient temperature and the stirrer is switched off. After the solid had settled, the supernatant liquid phase (mother liquor) was taken off. The solid was subsequently resuspended in fresh diesel oil (hydrogenated petroleum fraction having a boiling range from 140 to 170° C.) and after a stirring time of 15 minutes and subsequent complete settling of the solid, the supernatant liquid phase was taken off again. This washing procedure was repeated four times.

The molar ratio of the solid (catalyst component A) was: Mg:Ti:Cl≈1:0.31:2.46.

### b) Ethylene Polymerization in Suspension:

The polymerization experiments were carried out batchwise in a 200 dm³ reactor. This reactor was equipped with an impeller stirrer and baffles. The temperature in the reactor was measured and automatically kept constant. The polymerization temperature was 85±1° C. The polymerization reaction was carried out in the following way:

100 dm³ of diesel oil (hydrogenated petroleum fraction having a boiling range from 140 to 170° C.) were placed in the N2-blanketed reactor and heated to 85° C. Under a blanket of inert gas (N₂), 50 mmol of triethylaluminum diluted to 200 cm³ with diesel oil were added as cocatalyst (catalyst component B) and the catalyst component (A) prepared as described under a) was subsequently introduced into the reactor in an amount corresponding to 3.0 mmol of titanium as a suspension diluted with diesel oil.

The reactor was pressurized a number of times with H₂ (hydrogen) to 8 bar and depressurized again to remove the nitrogen completely from the reactor (the procedure was monitored by measurement of the H₂ concentration in the gas space of the reactor, which finally indicated 95% by volume). The polymerization was started by opening the ethylene inlet. Ethylene was introduced in an amount of 8.0 kg/h over the entire polymerization time, with the pressure in the reactor rising slowly. The concentration of hydrogen in the gas space of the reactor was measured continually and the proportion by volume was kept constant by introducing appropriate amounts of hydrogen (% by volume of H₂ about 40).

The polymerization was stopped after 225 minutes (total of 30 kg of ethylene gas fed in). For quantification of catalyst productivity the specific mileage is determined as follows:

Specific mileage=kg polyethylene/(mmol titanium*bar_{ethylene}*polymerization-time in hours). The results of the polymerizations are shown in Table 1.

### Example 2

Example 2 was performed in the same way as described in example 1 with the exception that isobutyltriethoxysilane was used instead of phenyltriethoxysilane.

The molar ratio of the solid (catalyst component A) was: Mg:Ti:Cl≈1:0.31:2.46. The polymerization was carried out as described in Example 1. The results of the polymerizations are listed in Table 1.

### Example 3

Example 3 was performed in the same way as described in example 1 with the exception that cyclopentyltriethoxysilane was used instead of phenyltriethoxysilane. The molar ratio of the solid (catalyst component A) was: Mg:Ti:Cl≈1:0.31:2.41. The polymerization was carried out as described in Example 1. The results of the polymerizations are listed in Table 1.

### Example 4

Example 4 was performed in the same way as described in example 1) with the exception that n-propyltriethoxysilane was used instead of phenyltriethoxysilane. The molar ratio of the solid (catalyst component A) was: Mg:Ti:Cl≈1:0.32:2.40. The polymerization was carried out as described in Example 1. The results of the polymerizations are listed in Table 1.

### Example 5

Example 5 was performed in the same way as described in example 1 with the exception that methyltripropoxysilane was used instead of phenyltriethoxysilane. The molar ratio of the solid (catalyst component A) was: Mg:Ti:Cl≈1:0.30:2.41. The polymerization was carried out as described in Example 1. The results of the polymerizations are listed in Table 1.

### Comparative Example 1

Comparative example 1 was performed in the same way as described in example 1 with the exception that no silane component was added. The molar ratio of the solid (catalyst component A) was: Mg:Ti:Cl≈1:0.30:2.39. The polymerization was carried out as described in Example 1. The results of the polymerizations are listed in Table 1.

TABLE 1

| | specific | | | | | |
|---|---|---|---|---|---|---|
| | mileage | | | | Bulk | |
| | kgPE/ | MFR_{5/190} | | | density | D₅₀ |
| Example | (mmolTi*P_{C2}*h) | g/10 min | FRR_{21.6/5} | FRR_{21.6/2.16} | g/dm³ | μm |
| 1 | 0.69 | 2.5 | 9.0 | 24.9 | 379 | 192 |
| 2 | 0.75 | 2.4 | 8.4 | 24.7 | 358 | 213 |
| 3 | 0.79 | 2.4 | 9.3 | 20.8 | 367 | 201 |
| 4 | 0.74 | 2.7 | 9.2 | 25.7 | 385 | 184 |
| 5 | 1.45 | 2.7 | 9.3 | 31.3 | 353 | 277 |
| C1 | 1.72 | 4.1 | 11.3 | 35.9 | 342 | 230 |

1. A catalyst component for the polymerization of olefins obtained by:
(a) reacting a Mg(OR₁)(OR₂) compound, wherein R₁ and R₂ are identical or different and are each an alkyl radical having 1 to 10 carbon atoms, with a tetravalent transition metal compound having at least a metal-halogen bond, the molar ratio metal/Mg ranging from 0.05 to 10, thereby obtaining a solid reaction product, and
(b) contacting the solid reaction product obtained in step (a) with a silicon compound of formula R^{I}Si(OR^{II})₃ where R^{I} is a linear, branched, cyclic or aromatic C₁-C₂₀ hydrocarbon group and R^{II} is a linear, branched, cyclic or aromatic C₂-C₂₀ hydrocarbon group, the molar ratio of the silicon compound on the transition metal in the solid reaction product of step (a) ranging from 0.1 to 3.

2. The catalyst component according to claim 1 wherein R^{II} is a linear or branched C₂-C₅ alkyl.

3. The catalyst component according to claim 2 wherein R^{II} is a linear C₂-C₅ alkyl.

4. The catalyst component according to claim 3 wherein R^{II} is ethyl.

5. The catalyst component according to claim 1 wherein R^{I} is a linear, branched, cyclic alkyl radical or aryl radical having from 3 to 10 carbon atoms.

6. The catalyst component according to claim 5 wherein R^{I} is selected from propyl, isopropyl, isobutyl, cyclopentyl or phenyl.

7. The catalyst component according to claim 1 wherein R₁ and R₂ are alkyl groups having from 2 to 10 carbon atoms.

8. The catalyst component according to claim 7 wherein the Mg(OR₁)(OR₂) compound is magnesium ethylate.

9. The catalyst component according to claim 1 wherein the tetravalent transition metal compound having at least a metal-halogen bond is TiCl₄.

10. The catalyst component according to claim 1 wherein magnesium alkoxide and the tetravalent transition metal compound are reacted in a molar ratio of Metal/Mg ranging from 0.1 to 3.

11. The catalyst component according to claim 1 wherein the solid reaction product of step (a) is contacted with an organometallic compound of a metal of group 1, 2 or 13 of the Periodic Table.

12. The catalyst component according to claim 11 wherein the organometallic compound selected from organoaluminum compounds.

13. The catalyst component according to claim 12 wherein the organoaluminum compounds are chlorine-containing organoaluminum compounds.

14. A catalyst system for the polymerization of olefins obtained by reacting the solid catalyst component according to claim 1 with a trialkylaluminum (component B).

15. A process for the polymerization of olefins carried out in the presence of the catalyst system of claim 14.
